(19) United States
(12) Patent Application Publication
(10) Pub. No.: US 2026/0125230 A1
(43) Pub. Date: May 7, 2026

(54) TOP LOAD CARTON CARRIER FOR A PACKAGING SYSTEM

(71) Applicant: R.A Jones & Co., Covington, KY (US)

(72) Inventor: Andrew James Nelson, Davenport, IA (US)

(21) Appl. No.: 19/372,855

(22) Filed: Oct. 29, 2025

Related U.S. Application Data
(60) Provisional application No. 63/715,111, filed on Nov. 1, 2024.

(51) Int. Cl. B65G 54/02; B65B 43/46; B65B 43/62; B65G 17/32; B65G 37/00

(52) U.S. Cl. CPC B65G 54/02; B65B 43/46; B65B 43/62; B65G 17/323; B65G 37/005

(57) ABSTRACT

A carrier comprising a pair of movers that are movable about a transport table of a cartoning system for transporting a carton. Each mover of the pair includes a carriage that is configured to operatively couple the mover to a track of the transport table for movement therealong and a jaw supported by the carriage. The jaw is rotatable about a pivot axis relative to the carriage such that the jaw is movable between a loading position, where a longitudinal axis of the jaw is approximately perpendicular to a travel direction of the mover along the track of the transport table, and an angled position, where the longitudinal axis of the jaw is angled relative to the travel direction of the mover. Each mover further includes a biasing member that is configured to apply an orienting force to the jaw to maintain the jaw in the loading position.

### CROSS-REFERENCE TO RELATED APPLICATION

The present application claims the filing benefit of U.S. Provisional Application Ser. No. 63/715,111, filed Nov. 1, 2024, the disclosure of which is incorporated herein by reference in its entirety.

### TECHNICAL FIELD

This invention relates generally to a cartoning or packaging system and, more particularly, to a carton carrier for use with a linear motion transfer system and method for moving a carton between stations of the cartoning system.

### BACKGROUND

In the packaging industry, linear motion transfer systems are used to automate the movement, sorting, and alignment of products along packaging lines. These systems generally consist of track-based configurations that enable devices to travel along a path defined by the track. The devices are used to receive and transport products between locations. Operation of the devices to move products may be achieved through the use of linear motors, for example.

While current linear motion transfer systems offer numerous advantages, they face growing challenges presented by increasingly sophisticated packaging systems required to meet industry demands for greater speed and higher production volumes. In that regard, as demand in packaging industries grows, manufacturers require packaging solutions that can operate at even faster speeds, with enhanced precision and minimal downtime. Furthermore, these systems must be capable of handling varied packaging formats and varied travel paths between packaging stations of the system, all while maintaining operational efficiency and secure handling of the packages throughout their movement along the travel paths.

Accordingly, there remains a need for advancements in linear motion transfer systems that can address these industry demands.

### SUMMARY

According to one embodiment of the present invention, a carrier for use with a transport table for transporting cartons in a cartoning system is disclosed. The carrier includes a pair of independent and independently controllable movers that are movable about the transport table. The transport table includes a frame that supports a track that defines a movement path of the carrier along the transport table. Each mover of the pair of movers that form the carrier includes a carriage that is configured to operatively couple the mover to the track of the transport table for movement therealong, and a jaw supported by the carriage. The jaw is rotatable about a pivot axis relative to the carriage such that the jaw is movable between a loading position, where a longitudinal axis of the jaw is approximately perpendicular to a travel direction of the mover along the track of the transport table, and an angled position, where the longitudinal axis of the jaw is angled relative to the travel direction of the mover. Each mover further includes a biasing member connected between the carriage and the jaw. The biasing member is configured to apply an orienting force to the jaw to maintain the jaw in the loading position.

According to one aspect of the present invention, the pair of movers are configured to apply a clamping force to clamp the carton between the jaws of the pair of movers as the carrier travels along the track. In another aspect, a longitudinal axis of the jaw of a first mover of the pair of movers may be substantially parallel to a longitudinal axis of the jaw of a second mover of the pair of movers to form a parallel orientation of the pair of movers as the carrier travels along the track. In yet another aspect, the clamping force of the pair of movers may be sufficient to overcome the orienting force exerted by the biasing member. In that regard, the parallel orientation of the pair of movers may be maintained along curved and straight sections of the track of the transport table.

According to another embodiment, a mover for a transport table for transporting a carton in a cartoning system is provided. The transport table includes a frame that supports a track that defines a movement path of the mover along the transport table. The mover comprises a carriage that is configured to operatively couple the mover to the track of the transport table for movement therealong, and a jaw supported by the carriage. The jaw is rotatable about a pivot axis relative to the carriage such that the jaw is movable between a loading position, where a longitudinal axis of the jaw is approximately perpendicular to a travel direction of the mover along the track of the transport table, and an angled position, where the longitudinal axis of the jaw is angled relative to the travel direction of the mover. The mover also includes a biasing member supported by the carriage. The biasing member is configured to apply an orienting force to the jaw to maintain the jaw in the loading position.

According to one aspect, the jaw may be configured to rotate up to about 30° about the pivot axis when pivoting between the loading position and the angled position. In another aspect, the jaw may include a base surface configured to engage an underside of the carton and an upright clamping surface configured to engage a side of the carton. In yet another aspect, the carriage may include at least one permanent magnet that is configured to interact with electromagnetic coils in the track to move the mover along the transport table.

According to another aspect, the jaw may be coupled to the carriage with a swivel mount assembly that defines the pivot axis. The swivel mount assembly may comprise a base bracket attached to the carriage and a connector bracket rotatably coupled to the base bracket. The jaw may be attached to the connector bracket. The biasing member may be connected between the base bracket and the connector bracket to apply the orienting force to the connector bracket to maintain the jaw in the loading position. In one aspect, the biasing member may be positioned on a guide rod. The guide rod may be connected between the base bracket and the connector bracket. Moreover, the guide rod may extend between a first end and a second end, with the first end being pivotably coupled to the base bracket and the second end being coupled to the connector bracket.

According to yet another embodiment, the guide rod may include a slide that is slideable along a length of the guide rod. The slide may be biased toward the second end of the guide rod by the biasing member, and the slide may be attached to the connector bracket. For example, the slide may be pivotably coupled to the connector bracket. According to another embodiment, the swivel mount assembly may include a stop configured to limit rotational movement of the connector bracket relative to the base bracket.

According to another embodiment, a carrier movable about a track of a transport table is provided. The carrier comprises a first mover and a second mover according to any one of the aspects above. The first mover and the second mover being are spaced apart along the track to define a space therebetween that is configured to receive a carton. The first mover and the second mover are configured to apply a clamping force to hold the carton between the jaw of the first mover and the jaw of the second mover as the carrier travels along the track.

According to one aspect, a longitudinal axis of the jaw of the first mover may be substantially parallel to a longitudinal axis of the jaw of the second mover to form a parallel orientation of the first mover and the second mover as the carrier travels along the track. In another aspect, the parallel orientation of the first mover and the second mover may be maintained along a curved section and a straight section of the track.

According to another embodiment, a transport table for transporting a carton in a cartoning system is provided. The transport table comprises a frame, a track supported by the frame, and a carrier according to any one of the aspects above. According to yet another embodiment, a cartoning system including the transport table is provided.

According to one embodiment, a method of operating a carrier of a transport table for transporting a carton in a cartoning system is provided. The transport table includes a frame that supports a track that defines a movement path of the carrier along the transport table. The method comprises providing a carrier that includes a first mover and a separate second mover. Each mover comprises a carriage that is configured to operatively couple the mover to the track of the transport table for movement therealong and a jaw supported by the carriage that is rotatable about a pivot axis relative to the carriage. Each carrier also includes a biasing member supported by the carriage. The biasing member is configured to apply an orienting force to the jaw to maintain the jaw in a loading position wherein a longitudinal axis of the jaw is approximately perpendicular to a travel direction of the mover along the track of the transport table. The method includes receiving a carton into a space between the first mover and the second mover and applying a clamping force on the carton by moving at least one of the first mover or the second mover toward the other to hold the carton between the jaw of first mover and the jaw of the second mover. The longitudinal axis of the jaw of the first mover is substantially parallel to the longitudinal axis of the jaw of the second mover to form a parallel orientation of the first mover and the second mover as the carrier travels along the track.

According to one aspect, the method may include moving the first mover apart from the second mover along the track to form the space therebetween, and receiving the carton into the space. The method may also include maintaining the clamping force exerted on the carton to maintain the parallel orientation of the first mover and the second mover as the carrier moves along a curved section and a straight section of the track. For example, the method may include rotating the jaw of the first mover and rotating the jaw of the second mover as the carrier moves along a curved section of the track to maintain the parallel orientation of the first mover and the second mover.

Various additional features and advantages of the invention will become more apparent to those of ordinary skill in the art upon review of the following detailed description of one or more illustrative embodiments taken in conjunction with the accompanying drawings.

### BRIEF DESCRIPTION OF THE DRAWINGS

The accompanying drawings, which are incorporated in and constitute a part of this specification, illustrate one or more embodiments of the invention and, together with the general description given above and the detailed description given below, serve to explain the one or more embodiments of the invention.

FIG. 1 is a perspective view of a top load cartoning system having a transport table with a plurality of carriers for transferring cartons between stations of the top load cartoning system in accordance with one embodiment of the present invention.

FIG. 2 is a perspective view of the transport table of the top load cartoning system of FIG. 1, illustrating each pair of movers that forms a carrier configured to support and move a carton about the transport table.

FIG. 3 is a perspective view of an exemplary mover of the pair of movers that forms one carrier of the transport table.

FIG. 4 is a view similar to FIG. 3, illustrating additional details of the mover.

FIG. 5 is a partial disassembled view of the mover of FIGS. 3 and 4.

FIG. 6 is a schematic plan view of the mover of FIGS. 3-5, illustrating a jaw of the mover biased to a loading position.

FIG. 7 is a schematic cross-sectional view of the mover of FIG. 6, illustrating additional details of the mover when in the loading position.

FIG. 8 is a view similar to FIG. 7, illustrating the mover swiveled from the loading position to an angled position.

FIG. 9 is a plan view of a carrier supporting a carton as the carrier moves along a straight section of track of the transport table.

FIG. 10 is a view similar to FIG. 9, illustrating the carrier supporting the carton as the carrier moves along a curved section of track of the transport table.

### DETAILED DESCRIPTION

Aspects of the present invention are directed to a cartoning system that forms, fills, and seals cartons for product packaging. The cartoning system may alternatively be referred to as a packaging system. In general, the cartoning system is configured to receive finished product and transfer the finished product to erected cartons. Additionally, the cartoning system is configured to seal each carton to securely contain the product in the cartons for bulk packaging. As described in further detail below, the cartoning system includes a transport table that supports a plurality of carriers (e.g., a fleet of carriers). Each carrier is configured to receive and efficiently transfer a respective erected carton between various stations of the cartoning system, such as a product filling station and a carton gluing and closing station by way of example. The fleet of carriers moves in a coordinated manner about the transport table to provide a continuous flow of erected cartons for filling with product and subsequent sealing.

Each carrier of the transport table comprises a pair of independent movers that are configured to securely clamp and hold an erected carton therebetween for transporting the carton along a predetermined travel path defined by the transport table. Each mover includes tooling in the form of a jaw for engaging one side of a carton, and each pair of movers may be independently controlled to generate the necessary clamping force to secure the carton between the jaws of the pair of movers. The movers are not interconnected or tethered, for example. Each carrier is configured to maintain the clamping force between the pair of movers that is exerted on opposite sides of the carton as the movers travel along both straight and curved track sections of the transport table. Specifically, the jaw of each mover is configured to rotate about a pivot, allowing each jaw to swivel or pivot between a loading position, where a longitudinal axis of the jaw is generally perpendicular to a movement direction of the mover, and an offset or angled position, where the longitudinal axis of the jaw is angled relative to the movement direction and a centerline axis of the mover. As a result of the pivotability of the jaw of each mover, the pair of jaws of a respective pair of movers is maintained parallel throughout the travel path so that the clamping force exerted by the jaws on the opposite sides of the carton may be maintained evenly along the carton, especially as the movers traverse non-linear movement paths, such as curved sections of the transport table. These and other benefits of the present invention will be described in further detail below.

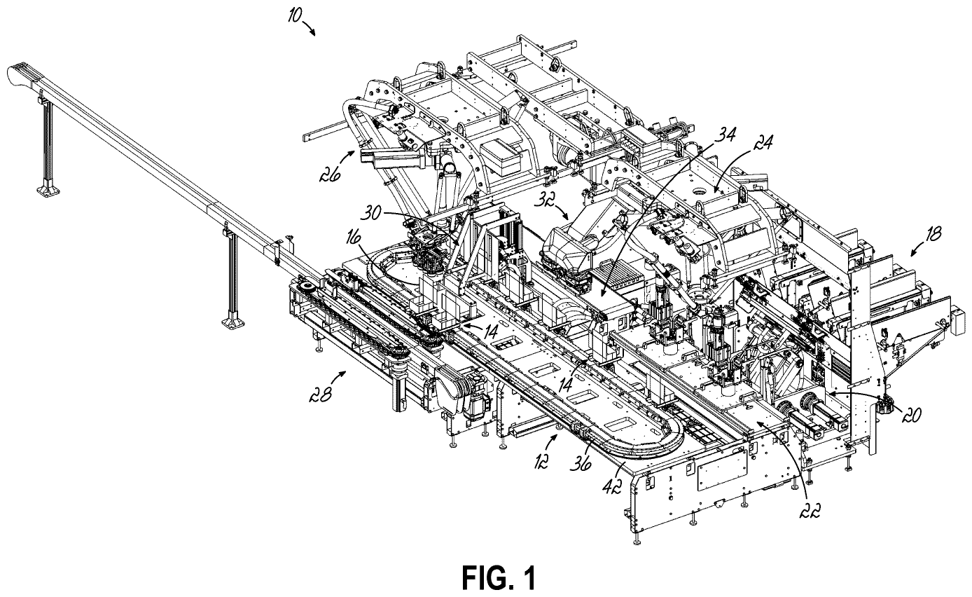

Referring now to the figures, FIG. 1 illustrates an exemplary cartoning system 10 having a transport table 12 with which one or more carton carriers 14 (referred to hereafter as a “carrier”) may be used in accordance with embodiments of the present invention. The cartoning system 10 may be a top load cartoning system. As briefly described above, the cartoning system 10 is configured to form, fill and seal one or more products into erect cartons 16 for distribution. As will be understood by a person skilled in the art of packaging, cartoning systems include several interconnected stations that handle various packaging tasks, such as carton blank feeding, carton forming, carton loading, carton sealing, and discharging. In that regard, the exemplary cartoning system 10 includes at least a carton magazine 18, a carton feed 20, a carton forming station 22 including a carton former 24, the transport table 12, a loading robot 26, a product infeed conveyor 28, a gluing station 30, a closing robot 32, and a discharge conveyor 34.

With continued reference to FIG. 1, the carton magazine 18 is configured to store a number of flat cartons, or carton blanks, before they are fed into the cartoning system 10 for processing. In particular, each carton magazine 18 is configured to hold multiple carton blanks in a stack, and is configured to supply carton blanks to the carton feed 20 as needed, ensuring a continuous workflow of carton blanks. The carton feed 20 retrieves carton blanks from the carton magazine 18 and moves the carton blanks to the carton forming station 22. For example, the carton feed 20 may include belts, conveyors, or mechanical arms for transferring carton blanks to the carton forming station 22. At the carton forming station 22, the carton blanks are transformed or erected into their three-dimensional shapes. In that regard, the carton forming station 22 may include a carton former 24 that assists in the carton forming process by folding and securing the erected cartons 16 as they are formed. The carton forming station 22 may further include a mechanical arm, such as a ram, that is configured to move each erected carton 16 from the carton forming station 22 to the transport table 12 where each erect carton 16 is to be filled with product.

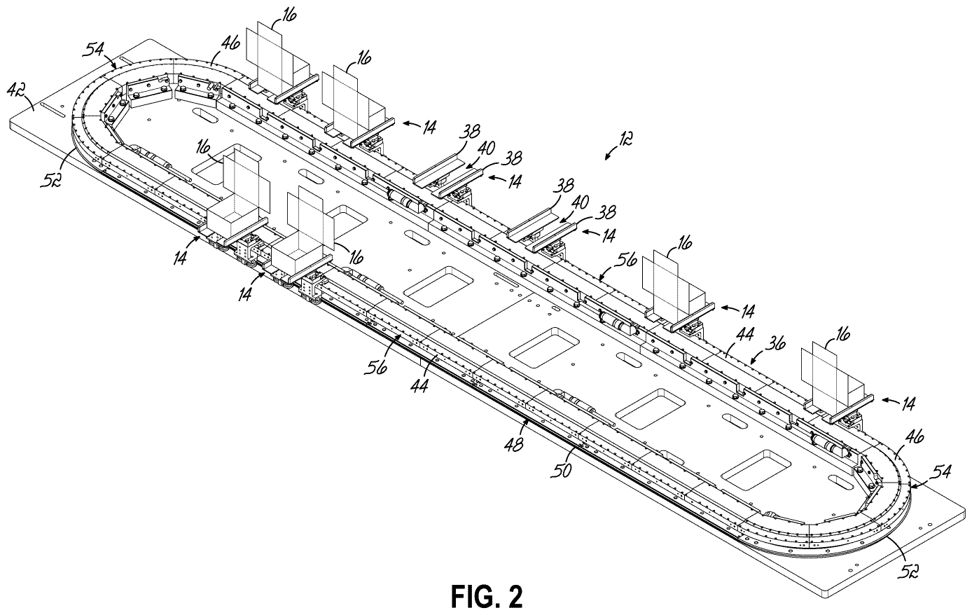

Each formed carton 16 (“carton”) is configured to be received onto the transport table 12 by a respective carrier 14, as will be described in further detail below. Each carton 16 is conveyed by a carrier 14 along a travel path defined by a track 36 of the transport table 12. Each carrier 14 comprises a pair of independent movers 38 that are positioned adjacent each other along the track 36 of the transport table 12, yet spaced apart to define a space 40 (FIG. 2) to receive a carton 16 between the pair of movers 38 which may be generally the same width as the carton 16 or slightly larger. The space 40 between each pair of movers 38 of a carrier 14 is generally maintained or adjusted to receive and transport a carton 16 along the track 36 of the transport table 12. While the cartons 16 are being moved along the travel path, the pair of jaws of the pair of movers 38 provides a clamping force to securely hold the carton 16 along the travel path. In that regard, each carrier 14 transports a carton 16 from the carton forming station 22 to the product infeed conveyor 28 where each carton 16 is filled with product by the loading robot 26. Next, the filled cartons 16 are moved to the gluing station 30 and then to the closing robot 32, where the filled cartons 16 are removed from the transport table 12 and onto the discharge conveyor 34 for further processing. In this manner, the transport table 12 may convey approximately 30 to 200 cartons 16 per minute, for example.

The loading robot 26, which may otherwise be referred to as a product picking robot, may include an end-of-arm-tool (EOAT) for picking product(s) from the product infeed conveyor 28 for placement into each carton 16 as the carton 16 is moved along the track 36 of the transport table 12 by the carrier 14. Once filled with product, the cartons 16 are progressed along the transport table 12 to the gluing station 30, where adhesive may be applied to the seams or flaps of each filled carton 16. The closing robot 32 is configured to close the carton 16 for final sealing, such as by folding down the top flap(s) of the carton 16, to ensure that the cartons 16 are properly sealed for transport and storage. The sealed cartons 16 are carried away from the cartoning system 10 by the discharge conveyor 34 for further processing, such as palletizing, labeling, and shipping.

The cartoning system 10 may include one or more control panels where appropriate control equipment (i.e., one or more controllers) for components of the cartoning system 10 are located. While Human Machine Interfaces (HMI) may be located on specific equipment, the control panel(s) may be where one or more HMIs and programmable logic controllers (PLC) are located, for example. To this end, according to embodiments of the present invention, components of the cartoning system 10 are responsive to stored programs for commanding operation of those components. The programs may be computer-readable program instructions for carrying out operations in accordance with the embodiments of the present invention. The computer-readable programs may be assembly language, source code, or object code written in any combination of one or more programming languages, and may be implemented using one or more computing devices or systems which may include a processor, a memory, an input/output (I/O) interface, and a Human Machine Interface (HMI), for example.

Referring now to FIG. 2, the transport table 12 of the cartoning system 10 is shown in isolation. The transport table 12 includes a frame 42 that supports a plurality of straight track segments 44 and curved track segments 46 that are connected together in an end-to-end arrangement to form the track 36. The transport table 12 may also include a guide rail 48 supported by the frame 42. The guide rail 48 corresponds to the track 36, and likewise may include a plurality of straight rail segments 50 and curved rail segments 52 that are connected together in an end-to-end arrangement. Each carrier 14 comprises of a pair of independent movers 38 that are operated in a coordinated manner to form the carrier 14 for transporting a carton 16, as will be described in further detail below. The movers 38 are operatively supported on the track 36 and movable along the track 36 which defines a travel path for the movers 38 and thus each carrier 14 about the transport table 12. The transport table 12 may be the XTS linear product transport system that is commercially available from Beckhoff Automation LLC (Savage, MN), for example. In the embodiment shown, the track 36 of the transport table 12 is a closed loop in the form of an oval, including curved track sections 54 at opposite ends of the transport table 12 connected by two straight track sections 56. However, the transport table 12 may be configured to have various closed loop track configurations, including linear, circular, and combinations thereof to form complex custom track 36 configurations, for example. To that end, the closed loop oval shape of the track 36 of the transport table 12 is not intended to be limiting.

The transport table 12 includes a linear motor system that is configured to propel each mover 38 along the track 36 of the transport table 12 in a coordinated manner to form the carrier 14 for transporting a carton 16. In that regard, each track segment 44, 46 houses embedded electromagnetic coils that enable motion control of the movers 38 that form each carrier 14. That is, the linear motor system of the transport table 12 is defined by a series of electromagnetic coils embedded along the track 36, which, when activated in sequence, create a moving magnetic field that propels the movers 38 along the track 36.

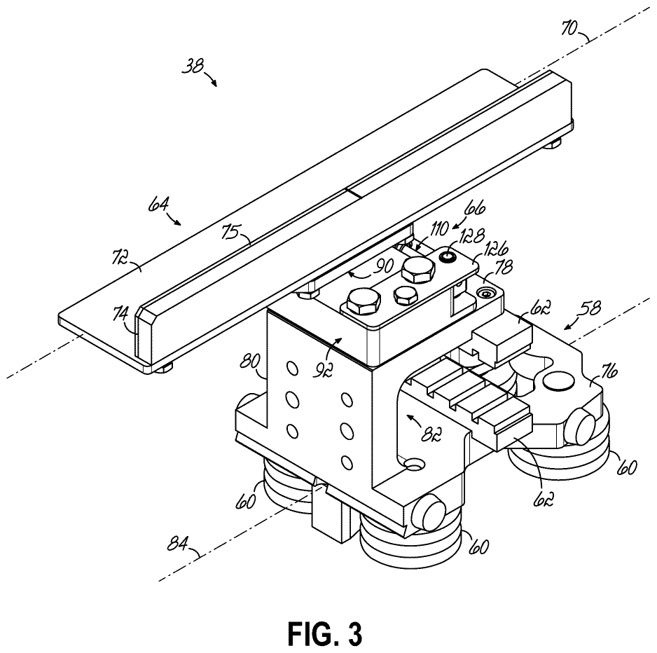

Referring now to FIGS. 2 and 3, each mover 38 includes a carriage 58 that supports one or more guide members, such as guide rollers 60, that are configured to interface with the guide rail 48 of the transport table 12. As the guide rail 48 aligns with the track 36 of the transport table 12, the carriage 58 couples each mover 38 to the guide rail 48, with the guide rollers 60 ensuring smooth and controlled movement of the carriage 58 as the linear motor system of the track 36 propels the mover 38 along the guide rail 48. In that regard, each mover 38 includes permanent magnets 62 that are configured to interact with the electromagnetic coils embedded in the track 36, and in particular each track segment 44, 46 that forms the track 36, allowing for propulsion of the movers 38 in a movement direction about the track 36 and the guide rail 48. To that end, the position, speed, and acceleration of each mover 38 may be precisely controlled independently of one another. Each mover 38 may be controlled based on a position of the mover 38, a velocity of the mover 38, or by force acting on or exerted by the mover 38.

Referring now to FIGS. 3-5, additional details of an exemplary mover 38 will now be described. As briefly described above, a pair of movers 38 form each carrier 14 that is configured to receive and transport a carton 16. In that regard, one mover 38 of the pair may be considered an upstream mover 38 and the other mover 38 of the pair may be considered a downstream mover 38. The terms “upstream” and “downstream” are used to identify each mover 38 relative to the travel path of the carrier 14 along the track 36 of the transport table 12. Specifically, the upstream mover 38 is positioned ahead of, and spaced from, the downstream mover 38 as the carrier 14 advances along the track 36. The upstream and downstream movers 38 have mirror configurations. Accordingly, although only one exemplary mover 38 (i.e., the downstream mover 38) is shown and described, this description also applies to the upstream mover 38.

With continued reference to FIGS. 3-5, the mover 38 includes tooling in the form of a jaw 64 which is operatively coupled to the carriage 58 of the mover 38 by a swivel mount assembly 66. The swivel mount assembly 66 defines a pivot joint that permits the jaw 64 to swivel (pivot or rotate) about a pivot axis 68 between the loading position, where a longitudinal axis 70 of the jaw 64 is approximately perpendicular to a travel direction of the mover 38 along the track 36 of the transport table 12, and an angled position, where the longitudinal axis 70 of the jaw 64 is angled relative to the travel direction of the mover 38. The jaw 64 is configured to engage one side of a carton 16, and in the embodiment shown, the jaw 64 is in the form of an elongate, L-shaped bracket, that extends a length along the longitudinal axis 70 between opposite ends of the jaw 64. In particular, the jaw 64 defines a base surface 72, which may be configured to engage the underside of a carton 16, and an upright clamping surface 74 that may be configured to engage a side or sidewall of a carton 16. The clamping surface 74 may include a gripping pad 75 that at least partially, and preferably substantially or entirely, covers the clamping surface 74 to facilitate secure engagement with a sidewall of the carton 16. The gripping pad 75 may be formed of foam or rubber, for example, and may be adhered to the jaw 64.

The carriage 58 of the mover 38 includes a generally C-shaped body having a base portion 76 and a top portion 78 spaced apart by an upright neck 80. Both the base portion 76 and the top portion 78 extend outward from the neck 80 to form the C-shaped configuration of the carriage 58 and a space 82 to receive a portion of the track 36 of the transport table 12. The carriage 58 includes a centerline axis 84 that, when the mover 38 is arranged on the track 36, is generally perpendicular to a movement direction of the mover 38. The top portion 78 of the carriage 58 includes a magnet 62 positioned to face the section of the track 36 of the transport table 12 that is received within the carriage 58. Similarly, the base portion 76 also includes a magnet 62 aligned to face the track 36 of the transport table 12. By interacting with the electromagnetic coils embedded in the track 36, the magnets 62 enable precise motion control of the carriage 58 and thus the mover 38 along the track 36 of the transport table 12. To that end, the base portion 76 of the carriage 58 includes the guide rollers 60 which are configured to engage and travel along the guide rail 48 of the transport table 12.

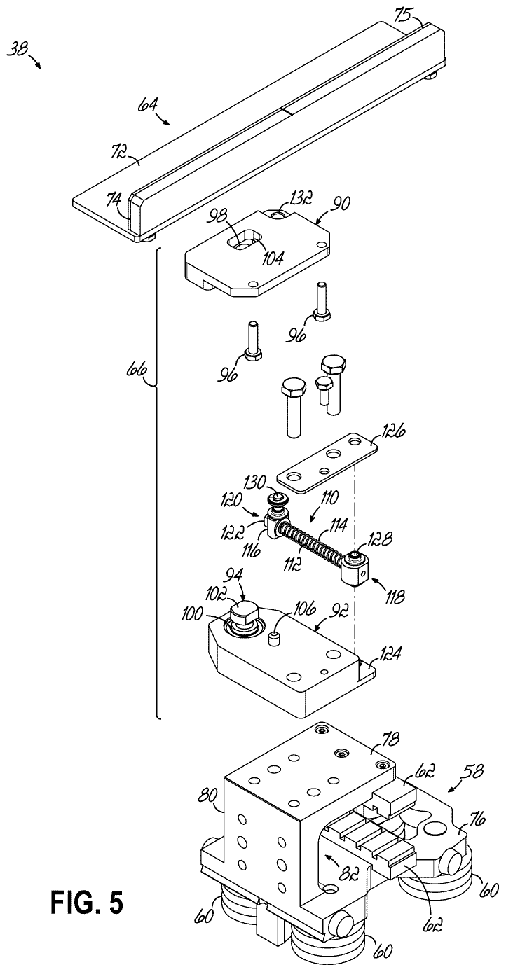

As briefly described above, the jaw 64 of the mover 38 is operatively connected to the carriage 58 via the swivel mount assembly 66 to permit swiveling or pivoting of the jaw 64 relative to the carriage 58. The swivel mount assembly 66 includes a connector bracket 90 and a base bracket 92 that are rotatably coupled together with a pivot pin 94. The jaw 64 of the mover 38 may be attached to the connector bracket 90 with appropriate fasteners 96 (FIG. 5), such as screws or bolts, for example. Similarly, the base bracket 92 is configured to be attached to the top portion 78 of the carriage 58 of the mover 38 with suitable fasteners, thereby permitting the jaw 64 to swivel relative to the carriage 58.

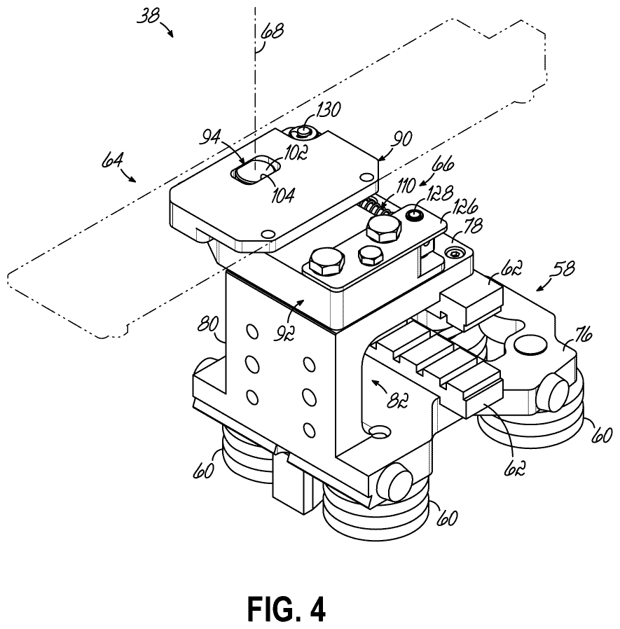

The connector bracket 90 is rotatable or pivotable relative to the base bracket 92 about the pivot pin 94, which defines the pivot axis 68 about which the jaw 64 is configured to swivel. The pivot pin 94 extends through a bore 98, 100 in both the connector bracket 90 and the base bracket 92, respectively, to operatively couple the connector bracket 90 to the base bracket 92. The bore 100 in the base bracket 92 may include a bearing or bushing to facilitate the rotation of the pivot pin 94 relative to the base bracket 92. Additionally, the pivot pin 94 includes a head 102 that fits into a counterbore 104 of the bore 98 of the connector bracket 90, allowing the jaw 64 to be mounted flush against the connector bracket 90 without interference from the pivot pin 94 (e.g., FIG. 4). The counterbore 104 and head 102 of the pin 94 are correspondingly shaped to ensure positive engagement of the pivot pin 94 by the connector bracket 90 to rotate the pivot pin 94 relative to the base bracket 92.

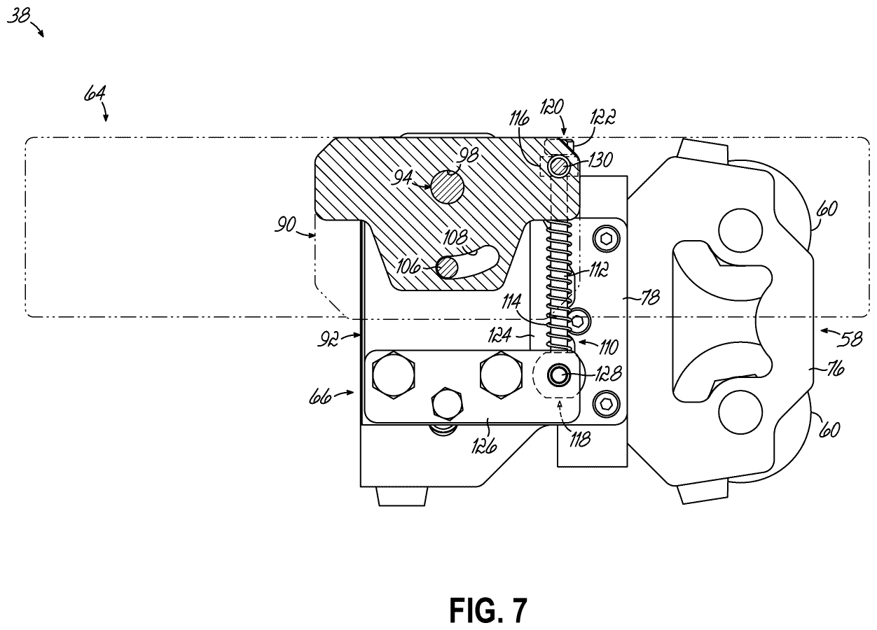

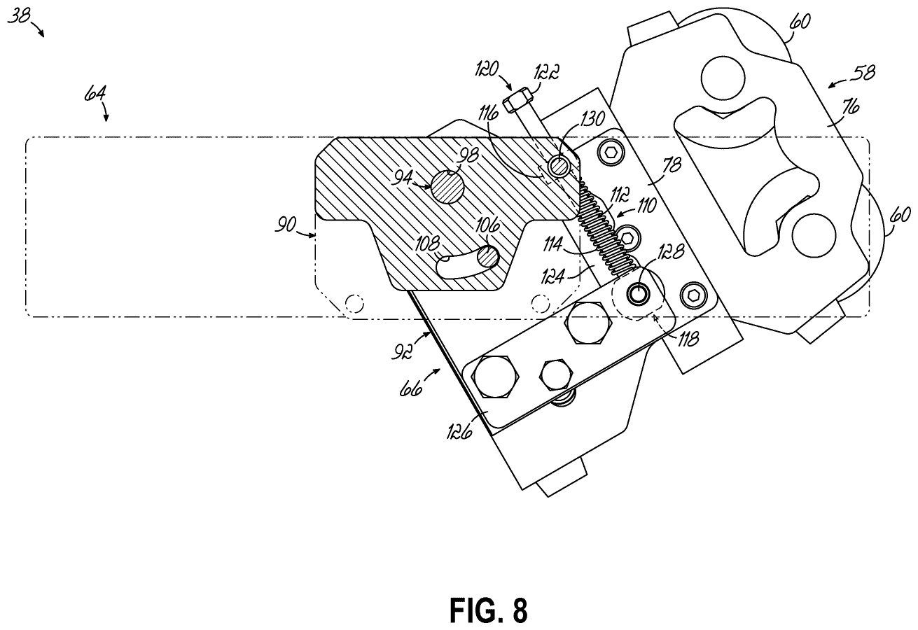

As best shown in FIGS. 5, 7 and 8, the base bracket 92 further includes a stop in the form of a guide pin 106 that is configured to limit the rotational or swiveling movement of the connector bracket 90 relative to the base bracket 92, and thus the jaw 64 relative to the carriage 58. The guide pin 106 fits into an arcuate-shaped blind slot 108 formed on the underside of the connector bracket 90 (e.g., FIG. 7), being the side of the connector bracket 90 that faces the base bracket 92 when the two are coupled. The length of the blind slot 108 accommodates the full range of swiveling movement permitted for the connector bracket 90 relative to the base bracket 92, and thus for the jaw 64 relative to the carriage 58. As will be described in further detail below, the guide pin 106 is positioned adjacent to, or abutting, one end of the blind slot 108 when the jaw 64 is in the loading position. As the jaw 64 swivels from the loading position to the angled position, the guide pin 106 travels along the blind slot 108. When in the angled position, the guide pin 106 is adjacent to, or abutting, the opposite end of the blind slot 108. In this way, the blind slot 108 effectively limits the extent to which the jaw 64 may swivel relative to the carriage 58.

Returning to FIGS. 3-5, the swivel mount assembly 66 further includes a biasing assembly 110 that is connected between the base bracket 92 and the connector bracket 90 to apply an orienting force to the connector bracket 90 to maintain the jaw 64 in the loading position (e.g., FIG. 3). More broadly speaking, the biasing assembly 110 is supported by the carriage 58 and is configured to apply an orienting force to the jaw 64 to maintain the jaw 64 in the loading position. The biasing assembly 110 includes a guide rod 112 that is configured to receive a biasing member, such as a spring 114, and a slide 116. The guide rod 112 extends a length between a first end 118 and a second end 120. The spring 114 is positioned on the guide rod 112, situated between the first end 118 of the guide rod 112 and the slide 116. The resting length of the spring 114 may be substantially similar to the length of the guide rod 112. Consequently, the biasing force of the spring 114 maintains a position of the slide 116 along the guide rod 112, being at the second end 120 of the guide rod 112. The second end 120 of the guide rod 112 may include a stop 122 to prevent the slide 116 from sliding off the second end 120 of the guide rod 112. The slide 116 is slideable along the length of the guide rod 112.

With continued reference to FIGS. 3-5, the base bracket 92 includes a ledge 124 for receiving the biasing assembly 110. Specifically, the guide rod 112 is arranged on the ledge 124 and generally extends along the ledge 124. The first end 118 of the guide rod 112 is operatively coupled between the ledge 124 and a mount bracket 126 using a pin 128. In other words, the first end 118 of the guide rod 112 is connected between the mount bracket 126 that is attached to the base bracket 92, and the ledge 124 of the base bracket 92, with the pin 128. The pin 128 forms a hinge at the first end 118 of the guide rod 112, allowing the guide rod 112 to pivot relative to the base bracket 92.

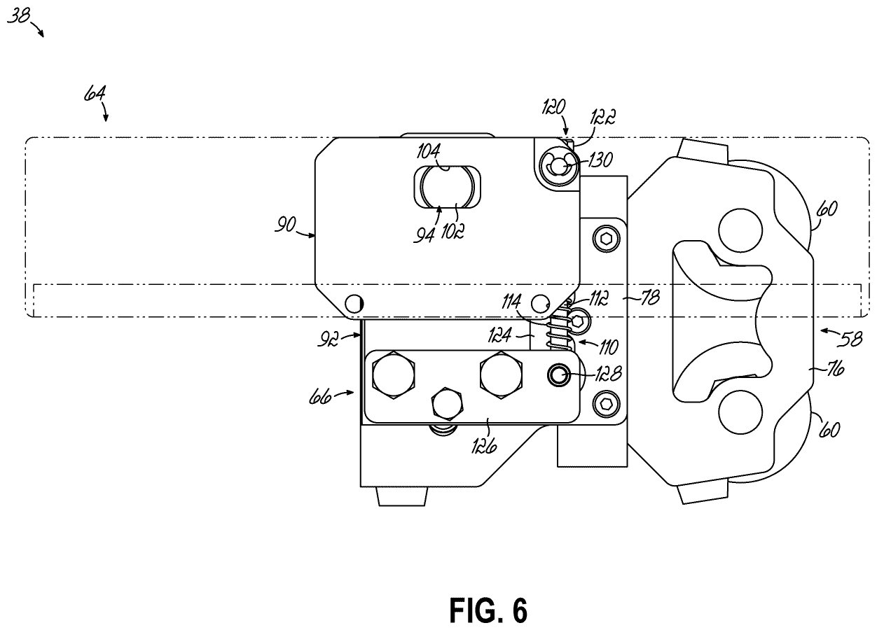

The biasing assembly 110 is attached to the connector bracket 90 of the swivel mount assembly 66 via the slide 116. Specifically, the slide 116 includes a pin 130 configured to be received through a bore 132 formed in the connector bracket 90 (e.g., FIGS. 6 and 7). The pin 130 forms a pivot, allowing the connector bracket 90 to pivot relative to the slide 116 and the guide rod 112. The second end 120 of the guide rod 112 of the biasing assembly 110 is not directly attached to either the base bracket 92 or the connector bracket 90. Instead, the second end 120 of the guide rod 112 is indirectly coupled to the connector bracket 90 via the slide 116, and in particular the pin 130. This coupling permits the spring 114 to bias the slide 116 toward the second end 120 of the guide rod 112, which, due to the attachment of the connector bracket 90 to the slide 116, results in the connector bracket 90 being biased as well. As shown in FIG. 7, the spring 114 biases the connector bracket 90 in this manner until movement of the connector bracket 90 is halted when the guide pin 106 abuts the first end of the blind slot 108. As a result, movement of the connector bracket 90, and thus the jaw 64, is halted in the loading position, where the jaw 64 is approximately perpendicular to the travel direction of the mover 38 along the track 36 of the transport table 12.

The biasing assembly 110 is configured to maintain the jaw 64 in the loading position as a result of the biasing force, otherwise referred to as orienting force, exerted by the spring 114 on the slide 116. That is, the biasing assembly 110, and in particular the spring 114, is configured to maintain the loading position of the jaw 64 in the absence of a sufficient external overcoming force exerted on the jaw 64 to overcome the biasing force of the spring 114. For each carrier 14, the jaws 64 of the respective pair of movers 38 are maintained in the loading position, i.e., generally parallel to each other, by the biasing assembly 110 so that the carrier 14 may receive a carton 16. Thus, when no carton 16 is positioned between the pair of movers 38, the jaws 64 are maintained in the loading position with the longitudinal axis 70 of each jaw 64 being generally perpendicular to the direction of travel of the carrier 14. As a result, the jaws 64 of the movers 38 are generally arranged parallel to one another. That is, the longitudinal axis 70 of each jaw 64 of the pair of movers 38 is parallel.

Once the carton 16 is received by the carrier 14, the pair of movers 38 are operated to apply a clamping force to retain the carton 16 therebetween. That is, the movers 38 are moved closer together, shrinking the space 40 between the movers 38, to thereby apply a clamping force on the carton 16. This clamping force maintains the parallel orientation of the jaws 64 of the pair of movers 38. In particular, the clamping force applied by the movers 38 on the carton 16 is sufficient to overcome the orienting force exerted on each jaw 64 by its respective biasing assembly 110. This allows the jaws 64 to swivel relative to the carriage 58 of each mover 38, enabling the jaws 64 to maintain parallel alignment to one another as the carrier 14 moves along the track 36. In other words, the clamping force exerted by the movers 38 on the carton 16 maintains the parallel orientation of the jaws 64.

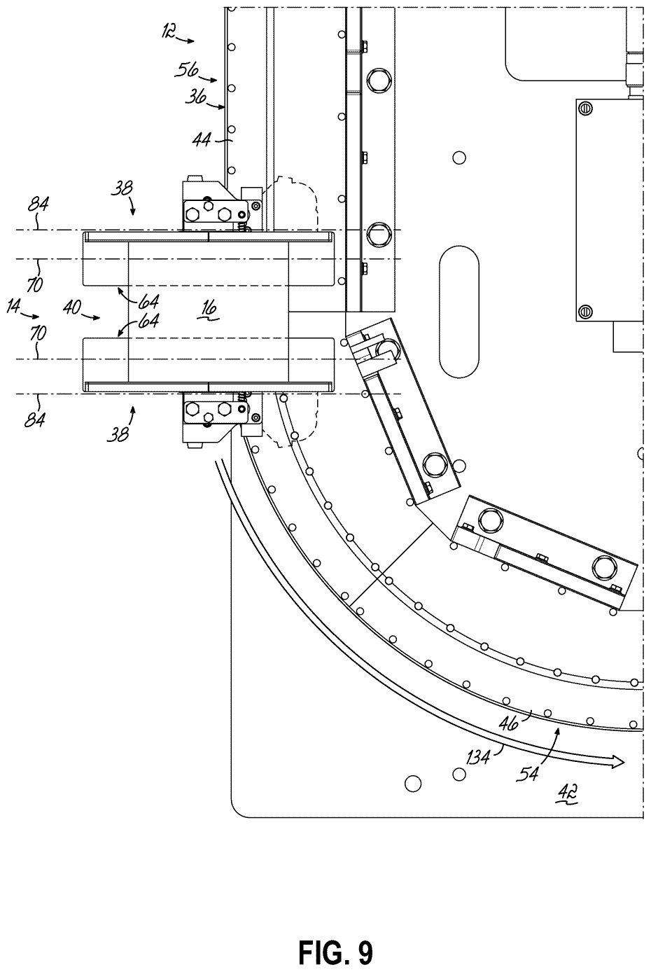

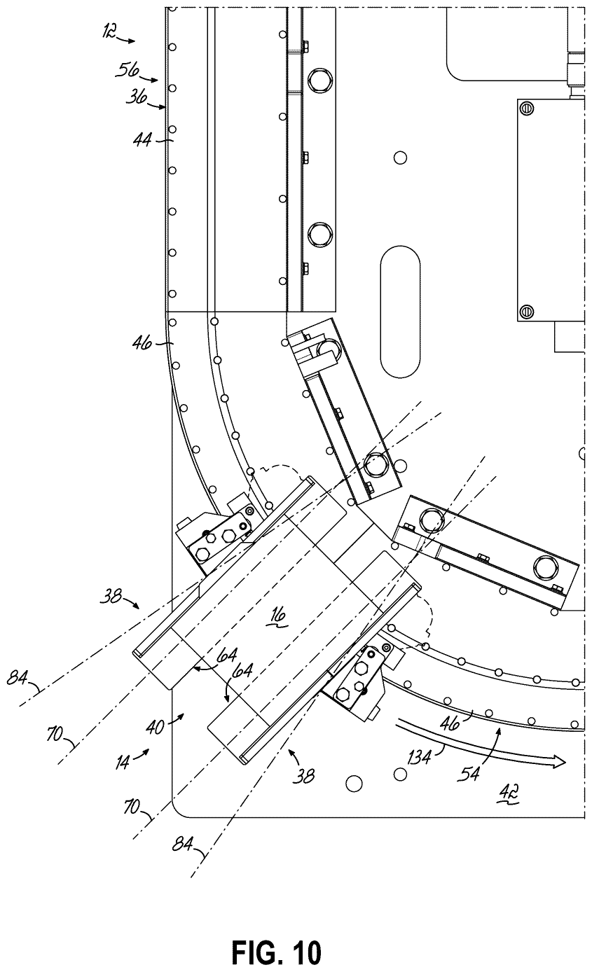

Referring now to FIGS. 9 and 10, the carrier 14 may traverse both straight and curvilinear paths along the track 36 of the transport table 12 while keeping the jaws 64 generally parallel to maintain an evenly distributed clamping force along the carton 16. As described above, because the jaws 64 of each mover 38 may swivel about the pivot axis 68, the carrier 14 is able to carry the carton 16 along curvilinear sections of the track 36 of the transport table 12. Specifically, the clamping force on the carton 16 maintains a parallel relationship between the jaws 64 of the pair of movers 38 along a straight section 56 of track 36 and a curved section 54 of track 36. In that regard, and with reference to FIG. 9, as the carrier 14 travels along a straight track section 56 in a movement direction 134, the longitudinal axis 70 of the jaws 64 are in parallel with one another. In that regard, the jaw 64 of both the upstream mover 38 and the downstream mover 38 are considered to be in the loading position, where the longitudinal axis 70 of each jaw 64 is generally perpendicular to the movement direction 134 of the carrier 14. Furthermore, the longitudinal axis 70 of the jaw 64 of the downstream mover 38 is generally parallel to the centerline axis 84 of the carriage 58. Likewise, the longitudinal axis 70 of the jaw 64 of the upstream mover 38 is generally parallel to the centerline axis 84 of the carriage 58.

As shown in FIG. 10, as the carrier 14 continues to travel in the movement direction 134 and along a curved track section 54, the clamping force exerted by the pair of movers 38 on the carton 16 overcomes the orienting force exerted by the biasing assembly 110 of each mover 38, and in particular the jaw 64 of each mover 38, thereby causing the jaws 64 to swivel from the loading position to an angled position to accommodate the curved track section 54 while maintaining the parallel orientation of the jaws 64 relative to one another. That is, the parallel orientation of the longitudinal axis 70 of the jaws 64 relative to one another is maintained throughout the curved track section 54 and while the jaw 64 of each mover 38 is in the angled position. However, when in the angled position, the longitudinal axis 70 of each jaw 64 is no longer in parallel with the centerline axis 84 of the carriage 58 of its respective mover 38. In particular, the longitudinal axis 70 of the jaw 64 of the downstream mover 38 is angled relative to the centerline axis 84 of its respective carriage 58. Likewise, the longitudinal axis 70 of the jaw 64 of the upstream mover 38 is also angled relative the centerline axis 84 of the carriage 58. The jaws 64 of each mover 38 may return to the loading position as the carrier 14 moves back onto a straight track section 56. In the embodiment shown, the swivel mount assembly 66 of each mover 38 may permit the jaw 64 to pivot or rotate up to about 30°, for example, when moving between the loading position and the angled position. However, it will be appreciated that the swivel mount assembly 66 may permit a greater or lesser degree of pivoting of the jaw 64 relative to the carriage 58 in other embodiments.

Having now described certain aspects of the transport table 12 and the carriers 14, a method of operating the transport table 12 to transport cartons 16 in the cartoning system 10 will now be described with reference to FIG. 1. As briefly described above, each pair of movers 38 that forms a carrier 14 are operated in a coordinated manner to form a space 40 between the jaws 64 to receive and support the carton 16. The distance between the movers 38, and in particular the jaws 64 of the movers 38, may be adjusted through positional control of the movers 38 along the track 36. To that end, at least one of the movers 38 of the pair may be changed to a force control method which is operable to exert a desired clamping force on the carton 16 arranged between the pair of movers 38.

As each carrier 14 moves along the transport table 12 past the carton forming station 22, the distance between the pair of movers 38 may be increased such that the space 40 between the jaws 64 of the movers 38 is substantially larger than the footprint of the carton 16 to be received. The carrier 14 may stop at predetermined positions along the track 36, such as below the carton former 24, for example. Carton forming ram(s) of the carton former 24 may move vertically downward, perpendicular to the plane of the track 36 and the transport table 12, with the carrier 14 being positioned directly beneath the ram and centered about the ram's central axis. The carton 16 may be deposited from the forming ram in between the pair of movers 38, with the carton 16 resting on the base surface 72 of each jaw 64 of the pair of movers 38. When so positioned, the position of one mover 38, such as the upstream mover 38, may be adjusted such that the jaw 64 is approximately co-planar to the nearest side of the carton 16 as it was deposited from the forming ram. The control method for the second mover 38, such as the downstream mover 38, is then changed from positional type control to a force control. In particular, the downstream mover 38 is configured to exert a force in a direction towards the upstream mover 38 to thereby clamp the carton 16 between the jaws 64 of the pair of movers 38. With the carton 16 clamped between the jaws 64 of the movers 38, the forming ram may retract. Once the forming ram is clear of the formed carton 16 and the carrier 14, the carrier 14 may continue to move along the track 36 of the transport table 12. The position and velocity of the upstream mover 38 may be controlled as the pair of movers 38 transits the track 36 of the transport table 12. The downstream mover 38 remains in force control constantly providing a clamping force on the carton 16.

As the carrier 14 travels along the track 36 of the transport table 12, the position and velocity of the pair of movers 38 may be varied according to the operations being performed. In that regard, the position and velocity of the upstream mover 38 may be directly controlled. As the position and velocity of the upstream mover 38 vary, the downstream mover 38 remains in force control with the force remaining directed toward the upstream mover 38, maintaining the clamping force exerted on the carton 16 to hold the carton 16 between the pair of movers 38. The magnitude of the clamping force may be varied as the carrier 14 travels along the track 36. Depending on the operations performed, geometry of the track 36, and the velocity and acceleration of the carrier 14, differing levels of clamping force may be required.

The carton 16 may be removed from the transport table 12 at any desired location along the track 36. In that regard, the location along the transport table 12 at which the carton 16 is removed may be anywhere along the track 36 after the carrier 14 has received a carton 16 from the carton former 24. In the exemplary cartoning system 10 shown in FIG. 1, as the carrier 14 enters the discharge area adjacent the discharge conveyor 34, operation of the downstream mover 38 may be changed from force control to a positional and/or velocity based control. The spacing between the upstream mover 38 and the downstream mover 38 may be increased such the space 40 between the pair of movers 38 is substantially larger than the carton 16. This relieves the clamping force that was applied to the carton 16 by the movers 38. This also allows a discharging device, such as the closing robot 32, to remove the carton 16 from the carrier 14. To that end, the carton 16 may be discharged from the carrier 14 using a robot, a pusher, or other suitable device that similarly removes the carton 16 from the carrier 14. Once the carton 16 is removed from the carrier 14, the carrier 14 returns to the forming station 22 to receive another carton 16 to repeat the process described above.

Approximating language, as used herein throughout the specification and claims, may be applied to modify any quantitative representation that could permissibly vary without resulting in a change in the basic function to which it is related. Accordingly, a value modified by a term or terms, such as “about,” “substantially,” and “approximately,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

As used herein, the terms “coupled,” “connected,” “attached,” and the like are intended to be broadly construed and are not limited to a direct connection or engagement unless explicitly stated otherwise. For example, elements described as being “coupled,” “connected,” or “attached” to one another may be directly coupled or connected, or they may be indirectly coupled or connected through one or more intermediate components or members.

While the invention has been illustrated by the description of various embodiments thereof, and while the embodiments have been described in considerable detail, it is not intended to restrict or in any way limit the scope of the appended claims to such detail. Thus, the various features discussed herein may be used alone or in any combination. Additional advantages and modifications will readily appear to those skilled in the art. The invention in its broader aspects is therefore not limited to the specific details and illustrative examples shown and described. Accordingly, departures may be made from such details without departing from the scope of the general inventive concept.

What is claimed is:

1. A mover for a transport table for transporting a carton in a cartoning system, the transport table including a frame that supports a track that defines a movement path of the mover along the transport table, the mover comprising:
a carriage that is configured to operatively couple the mover to the track of the transport table for movement therealong;
a jaw supported by the carriage, the jaw being rotatable about a pivot axis relative to the carriage such that the jaw is movable between a loading position, wherein a longitudinal axis of the jaw is approximately perpendicular to a travel direction of the mover along the track of the transport table, and an angled position, wherein the longitudinal axis of the jaw is angled relative to the travel direction of the mover; and
a biasing member supported by the carriage, the biasing member being configured to apply an orienting force to the jaw to maintain the jaw in the loading position.

2. The mover of claim 1, wherein the jaw is configured to rotate up to about 30° about the pivot axis when pivoting between the loading position and the angled position.

3. The mover of claim 1, wherein the jaw includes a base surface configured to engage an underside of the carton and an upright clamping surface configured to engage a side of the carton.

4. The mover of claim 1, wherein the carriage includes at least one permanent magnet that is configured to interact with electromagnetic coils in the track to move the mover along the transport table.

5. The mover of claim 1, wherein the jaw is coupled to the carriage with a swivel mount assembly that defines the pivot axis.

6. The mover of claim 5, wherein the swivel mount assembly comprises:
a base bracket attached to the carriage;
a connector bracket rotatably coupled to the base bracket, the jaw being attached to the connector bracket; and
the biasing member, wherein the biasing member is connected between the base bracket and the connector bracket to apply the orienting force to the connector bracket to maintain the jaw in the loading position.

7. The mover of claim 6, wherein the biasing member is positioned on a guide rod, the guide rod being connected between the base bracket and the connector bracket.

8. The mover of claim 7, wherein the guide rod extends between a first end and a second end, the first end being pivotably coupled to the base bracket and the second end being coupled to the connector bracket.

9. The mover of claim 8, wherein the guide rod includes a slide that is slideable along a length of the guide rod, the slide being biased toward the second end of the guide rod by the biasing member, and wherein the slide is attached to the connector bracket.

10. The mover of claim 9, wherein the slide is pivotably coupled to the connector bracket.

11. The mover of claim 6, wherein the swivel mount assembly includes a stop configured to limit rotational movement of the connector bracket relative to the base bracket.

12. A carrier movable about a track of a transport table, the carrier comprising:
a first mover according to claim 1 and a second mover according to claim 1, the first mover and the second mover being spaced apart along the track to define a space therebetween to receive a carton;
wherein the first mover and the second mover apply a clamping force to hold the carton between the jaw of the first mover and the jaw of the second mover as the carrier travels along the track.

13. The carrier of claim 12, wherein a longitudinal axis of the jaw of the first mover is substantially parallel to a longitudinal axis of the jaw of the second mover to form a parallel orientation of the first mover and the second mover as the carrier travels along the track.

14. The carrier of claim 13, wherein the parallel orientation of the first mover and the second mover is maintained along a curved section and a straight section of the track.

15. A transport table for transporting a carton in a cartoning system, the transport table comprising:
a frame;
a track supported by the frame; and
a carrier according to claim 12.

16. A cartoning system including the transport table of claim 15.

17. A method of operating a carrier of a transport table for transporting a carton in a cartoning system, the transport table including a frame that supports a track that defines a movement path of the carrier along the transport table, the method comprising:
providing a carrier, comprising:
a first mover and a separate second mover, each mover comprising:
a carriage that is configured to operatively couple the mover to the track of the transport table for movement therealong;
a jaw supported by the carriage and rotatable about a pivot axis relative to the carriage; and
a biasing member supported by the carriage, the biasing member being configured to apply an orienting force to the jaw to maintain the jaw in a loading position wherein a longitudinal axis of the jaw is approximately perpendicular to a travel direction of the mover along the track of the transport table;
receiving a carton into a space between the first mover and the second mover; and
applying a clamping force on the carton by moving at least one of the first mover or the second mover toward the other to hold the carton between the jaw of first mover and the jaw of the second mover;
wherein the longitudinal axis of the jaw of the first mover is substantially parallel to the longitudinal axis of the jaw of the second mover to form a parallel orientation of the first mover and the second mover as the carrier travels along the track.

18. The method of claim 17, further comprising:
moving the first mover apart from the second mover along the track to form the space therebetween; and
receiving the carton into the space.

19. The method of claim 17, further comprising:
maintaining the clamping force exerted on the carton to maintain the parallel orientation of the first mover and the second mover as the carrier moves along a curved section and a straight section of the track.

20. The method of claim 17, further comprising:
rotating the jaw of the first mover and rotating the jaw of the second mover as the carrier moves along a curved section of the track to maintain the parallel orientation of the first mover and the second mover.
